(19) United States
(12) Patent Application Publication
(10) Pub. No.: US 2014/0160092 A1
(43) Pub. Date: Jun. 12, 2014

(54) DIGITAL PEN AND DIGITAL WRITING APPARATUS

(71) Applicant: HON HAI PRECISION INDUSTRY CO., LTD., New Taipei (TW)

(72) Inventor: KUO-FONG TSENG, New Taipei (TW)

(73) Assignee: HON HAI PRECISION INDUSTRY CO., LTD., New Taipei (TW)

(21) Appl. No.: 13/893,351

(22) Filed: May 14, 2013

(30) Foreign Application Priority Data
Dec. 12, 2012 (TW) 101146913

(51) Int. Cl. G06F 3/0354

(52) U.S. Cl. CPC G06F 3/03542
USPC 345/182

(57) ABSTRACT

A digital pen includes a housing, a refill, a camera module, a controller, a memory, and an information transmission module. The housing includes an end. The refill is received in the housing and includes a tip capable of extending out of the end for writing on a writing medium. The camera module includes a lens, an image sensor and a processor. The image sensor captures images of the tips on the writing medium through the lens. The processor analyzes the images to obtain positions of the tips on the writing medium and to obtain a track of the tip. The controller is connected to the refill and the camera module, and controls the camera module to capture the images when the refill is pressed. The memory stores the track of the tip. The information transmission module transmits the track of the tip to a user terminal.

### BACKGROUND

1. Technical Field

The present disclosure relates to a digital pen and a digital writing apparatus including the digital pen.

2. Description of Related Art

A digital pen is used to input a handwriting of a user to an electronic device. A conventional digital pen uses a laser module and an ultrasonic wave module to track the handwriting of the user. Yet, the structure of the digital pen is complex as it uses the laser module and the ultrasonic wave module both.

Therefore, it is desired to provide a digital pen and a digital writing apparatus which can overcome the above mentioned problems.

### BRIEF DESCRIPTION OF THE DRAWINGS

FIG. 1 is a schematic view of a digital pen according to a first embodiment.

FIG. 2 is a schematic view of a digital writing apparatus according to a second embodiment.

### DETAILED DESCRIPTION

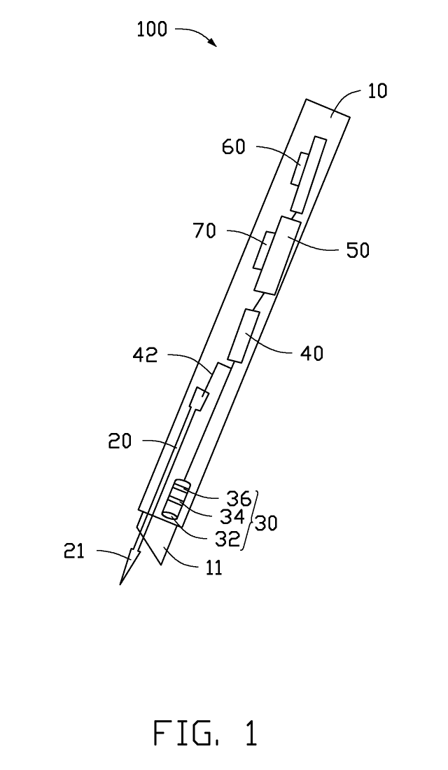

FIG. 1 shows a digital pen 100 according to a first embodiment. The digital pen 100 includes a housing 10 for housing a refill 20, a camera module 30, a controller 40, a memory 50, an information transmission module 60, and a battery 70.

The refill 20 includes a tip 21. The tip 21 can extend out of an end 11 of the housing 10 for writing, and can be retracted into the housing 10 when not being used. The refill 20 can be filled with ink.

The camera module 30 is adjacent to the tip 21. The camera module 30 is configured for capturing images of the tip 21 and analyzing the images to obtain a track of the tip 21. The camera module 30 includes a lens 32, an image sensor 34 and a processor 36. The image sensor 34 captures images of the tip 21 through the lens 32. The processor 36 analyzes the images captured by the image sensor 34 to obtain the positions of the tip 21, and to obtain the track of the tip 21.

The controller 40 is connected to the refill 20 and the camera module 30, and is configured for controlling the camera module 30 to begin to capture images when the refill 20 is pressed.

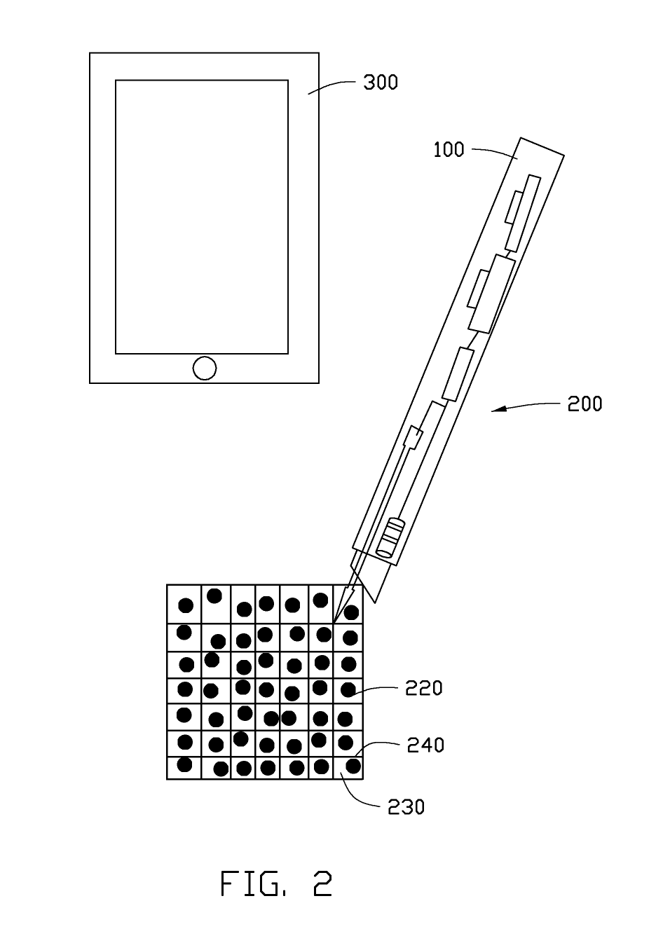

In one embodiment, the controller 40 includes a switch 42 connected to the refill 20. When the tip 21 is pressed on a writing medium 230 (see FIG. 2), the switch 42 is turned on, the controller 40 controls the camera module 30 to capture images of the tip 21. When the tip 21 is released, the switch 42 is turned off; the controller 30 controls the camera module 30 to stop capturing. The camera module 30 captures ten images a second, the processor 36 analyzes the images to obtain the position of the tip 21 in each image, and to obtain the track of the tip 21.

The track of the tip 21 is stored in the memory 50 and is transmitted to a user terminal 300 (see FIG. 2) through the information transmission module 60. In this embodiment, the information transmission module 60 is a wireless communication module.

The battery 70 supplies power to the camera module 30, the controller 40, the memory 50, and the information transmission module 60.

FIG. 2 shows a digital writing apparatus 200. The digital writing apparatus 200 includes the digital pen 100 and the writing medium 230. The writing medium 230 is a paper or a board. The writing medium 230 is divided into a plurality of rectangular cells 240. A plurality of identification points 220 are disposed on the writing medium 230. Each rectangular cell 240 receives an identification point 220. The identification points 220 are arranged in a way that the position of one identification point 220 in its rectangular cell 240 is different from the positions of any other identification points 220 in their rectangular cells 240. When the tip 21 contacts a specific rectangular cell 240, by identifying the position of the identification point 220 in the specific rectangular cell 240, the processor 36 identifies which the specific rectangular cell 240 is and obtains the position of the tip 21 on the writing medium 230. A plurality of sequential positions of the tip 21 on the writing medium 230 constitutes the track of the tip 21. In other embodiments, different identification points 220 maybe distinguished not by the positions in the rectangular cells 240, but by different colors, or different serial numbers.

The track of the tip 21 is stored in the memory 50 and is transmitted to the user terminal 300 through the information transmission module 60. The user terminal 300 is an electronic device, such as a computer or a mobile phone. The user terminal 300 shows the track of the tip 21.

The digital pen 100 uses only one camera module 30 to obtain the track of the tip 21, in this way, the structure of the digital pen 100 is simplified.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A digital pen comprising:
a housing comprising an end;
a refill received in the housing, the refill comprising a tip, the tip being capable of extending out of the end for writing on a writing medium;
a camera module comprising a lens, an image sensor and a processor, the image sensor being configured for capturing images of the tips on the writing medium through the lens, the processor being configured for analyzing the images to obtain positions of the tips on the writing medium and to obtain a track of the tip;
a controller connected to the refill and the camera module, and configured for controlling the camera module to capture the images when the refill is pressed;
a memory for storing the track of the tip; and
an information transmission module for transmitting the track of the tip to a user terminal.

2. The digital pen of claim 1, comprising a battery received in the housing and electrically connected to the camera module, the controller, the memory and the information transmission module.

3. The digital pen of claim 1, wherein the controller comprises a switch, the switch is turned on when the refill is pressed, and the controller controls the camera module to capture the images of the tip when the switch is on.

4. The digital pen of claim 1, wherein all of the camera module, the controller, the memory and the information transmission module are received in the housing, and the camera module is adjacent to the end of the housing.

5. A digital writing apparatus comprising:
a writing medium divided into a plurality of cells and comprising a plurality of identification points, each of the identification points received in a respective one of the cells, different identification points capable of being distinguishable from each other; and
a digital pen comprising:
a housing comprising an end;
a refill received in the housing, the refill comprising a tip, the tip being capable of extending out of the end for writing on the writing medium;
a camera module comprising a lens, an image sensor and a processor, the image sensor being configured for capturing images of the tips on the writing medium through the lens, the processor being configured for analyzing the images, determining which of the cells is touched by the tip via identifying the identification points, and obtaining positions of the tips on the writing medium to obtain a track of the tip;
a controller connected to the refill and the camera module, and configured for controlling the camera module to capture the images when the refill is pressed;
a memory for storing the track of the tip; and
a information transmission module for transmitting the track of the tip to a user terminal.

6. The digital writing apparatus of claim 5, wherein the position of any one of the identification points in its cell is different from the positions of any other identification points in their cells.

7. The digital writing apparatus of claim 5, wherein the identification points are distinguished from each other by colors.

8. The digital writing apparatus of claim 5, wherein the identification points are distinguished from each other by serial numbers.

9. The digital writing apparatus of claim 5, wherein the digital pen comprises a battery received in the housing and electrically connected to the camera module, the controller, the memory and the information transmission module.

10. The digital writing apparatus of claim 5, wherein the controller comprises a switch, the switch is turned on when the refill is pressed, and the controller controls the camera module to capture the images of the tip when the switch is on.

11. The digital writing apparatus of claim 5, wherein all of the camera module, the controller, the memory and the information transmission module are received in the housing, and the camera module is adjacent to the end of the housing.
